(19) United States
(12) Patent Application Publication
(10) Pub. No.: US 2018/0090815 A1
(43) Pub. Date: Mar. 29, 2018

(54) Phased Array Antenna Panel Having Quad Split Cavities Dedicated to Vertical-Polarization and Horizontal-Polarization Antenna Probes

(71) Applicant: Movandi Corporation, Newport Beach, CA (US)

(72) Inventors: Farid Shirinfar, Granada Hills, CA (US); Seunghwan Yoon, Irvine, CA (US); Alfred Grau Besoli, Irvine, CA (US); Maryam Rofougaran, Rancho Palos Verdes, CA (US); Sam Gharavi, Irvine, CA (US); Michael Boers, South Turramurra (AU); Ahmadreza Rofougaran, Newport Coast, CA (US)

(21) Appl. No.: 15/279,219

(22) Filed: Sep. 28, 2016

(51) Int. Cl. H01Q 1/22; H01Q 21/00; H01Q 1/52

(52) U.S. Cl. CPC H01Q 1/2283; H01Q 1/52; H01Q 21/0025

(57) ABSTRACT

A phased array antenna panel includes a substrate over a metallic base, a semiconductor die situated over the substrate, the semiconductor die being coupled to a vertical-polarization antenna probe and to a horizontal-polarization antenna probe, where the vertical-polarization antenna probe is situated over a dedicated vertical-polarization cavity, and where the horizontal-polarization antenna probe is situated over a dedicated horizontal-polarization cavity. The dedicated vertical-polarization cavity and the dedicated horizontal-polarization cavity reduce coupling between the vertical-polarization antenna probe and the horizontal-polarization antenna probe. The semiconductor die also includes a radio frequency (RF) front end circuit coupled to the vertical-polarization antenna probe and the horizontal-polarization antenna probe.

### RELATED APPLICATIONS)

The present application is related to U.S. patent application Ser. No. 15/225,071, filed on Aug. 1, 2016, Attorney Docket Number 0640101, and titled “Wireless Receiver with Axial Ratio and Cross-Polarization Calibration,” and U.S. patent application Ser. No. 15/225,523, filed on Aug. 1, 2016, Attorney Docket Number 0640102, and titled “Wireless Receiver with Tracking Using Location, Heading, and Motion Sensors and Adaptive Power Detection,” and U.S. patent application Ser. No. 15/226,785, filed on Aug. 2, 2016, Attorney Docket Number 0640103, and titled “Large Scale Integration and Control of Antennas with Master Chip and Front End Chips on a Single Antenna Panel,” and U.S. patent application Ser. No. 15/255,656, filed on Sep. 2, 2016, Attorney Docket No. 0640105, and titled “Novel Antenna Arrangements and Routing Configurations in Large Scale Integration of Antennas with Front End Chips in a Wireless Receiver,” and U.S. patent application Ser. No. 15/256,038 filed on Sep. 2, 2016, Attorney Docket No. 0640106, and titled “Transceiver Using Novel Phased Array Antenna Panel for Concurrently Transmitting and Receiving Wireless Signals,” and U.S. patent application Ser. No. 15/256,222 filed on Sep. 2, 2016, Attorney Docket No. 0640107, and titled “Wireless Transceiver Having Receive Antennas and Transmit Antennas with Orthogonal Polarizations in a Phased Array Antenna Panel,” and U.S. patent application Ser. No. 15/278,970 filed on Sep. 28, 2016, Attorney Docket No. 0640108, and titled “Low-Cost and Low-Loss Phased Array Antenna Panel,” and U.S. patent application Ser. No. 15/279,171 filed on Sep. 28, 2016, Attorney Docket No. 0640109, and titled “Phased Array Antenna Panel Having Cavities with RF Shields for Antenna Probes.” The disclosures of all of these related applications are hereby incorporated fully by reference into the present application.

### BACKGROUND

The next generation wireless communication networks may adopt very high frequency signals in the millimeter-wave range to deliver faster Internet speed and handle surging mobile network traffic. Thus, millimeter-wave antennas may be a crucial part of the next generation wireless communications systems. Due to the small sizes of millimeter-wave antennas, during transmission and reception operations, signal coupling may occur among the many antennas in an antenna panel as well as among individual millimeter-wave antenna probes of the same antenna. Signal coupling may lead to interference and result in undesirable beam patterns and reduced gain.

Accordingly, there is a need in the art for improving the performance of millimeter-wave antennas by reducing loss, and improving signal isolation, bandwidth, gain, directivity and radiation pattern.

### SUMMARY

The present disclosure is directed to a phased array antenna panel having quad split cavities dedicated to vertical-polarization and horizontal-polarization antenna probes, substantially as shown in and/or described in connection with at least one of the figures, and as set forth in the claims.

### BRIEF DESCRIPTION OF THE DRAWINGS

FIG. 1A illustrates a perspective view of a portion of a phased array antenna panel according to one implementation of the present application.

FIG. 1B illustrates a perspective view of a portion of a phased array antenna panel according to one implementation of the present application.

FIG. 2 illustrates a functional block diagram of a radio frequency front end circuit of a semiconductor die according to one implementation of the present application.

FIG. 3A illustrates a perspective view of quad split cavities of a phased array antenna panel according to one implementation of the present application.

FIG. 3B illustrates a perspective view of quad split cavities of a phased array antenna panel according to one implementation of the present application.

FIG. 4A illustrates a top plan view of quad split cavities of a phased array antenna panel according to one implementation of the present application.

FIG. 4B illustrates a top plan view of quad split cavities of a phased array antenna panel according to one implementation of the present application.

FIG. 5A illustrates a top plan view of a plurality of quad split cavities in a phased array antenna panel according to one implementation of the present application.

FIG. 5B illustrates a top plan view of a plurality of quad split cavities in a phased array antenna panel according to one implementation of the present application.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

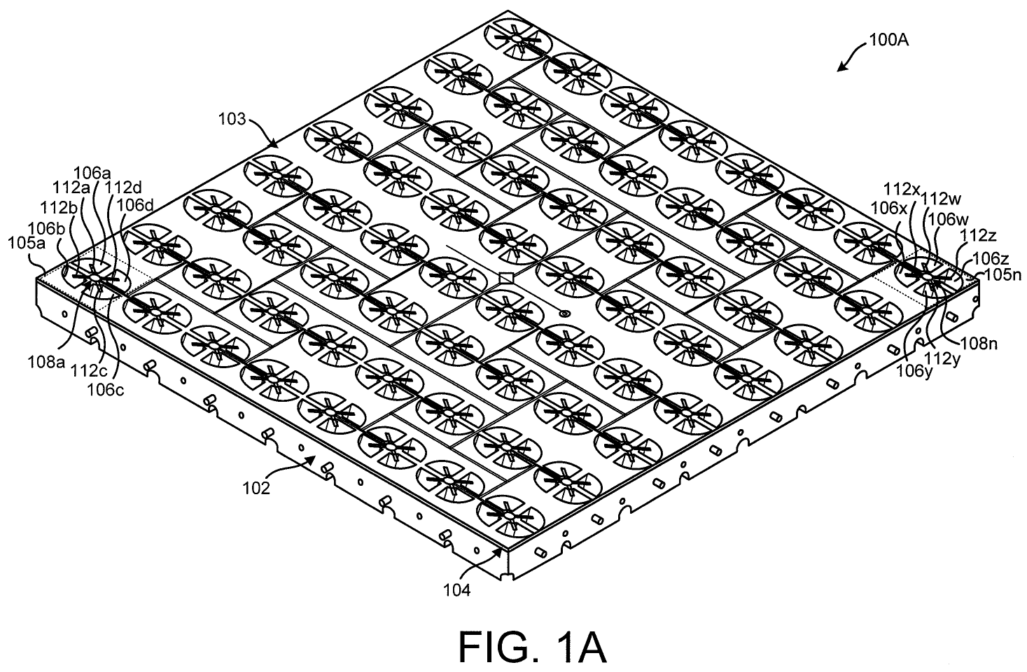

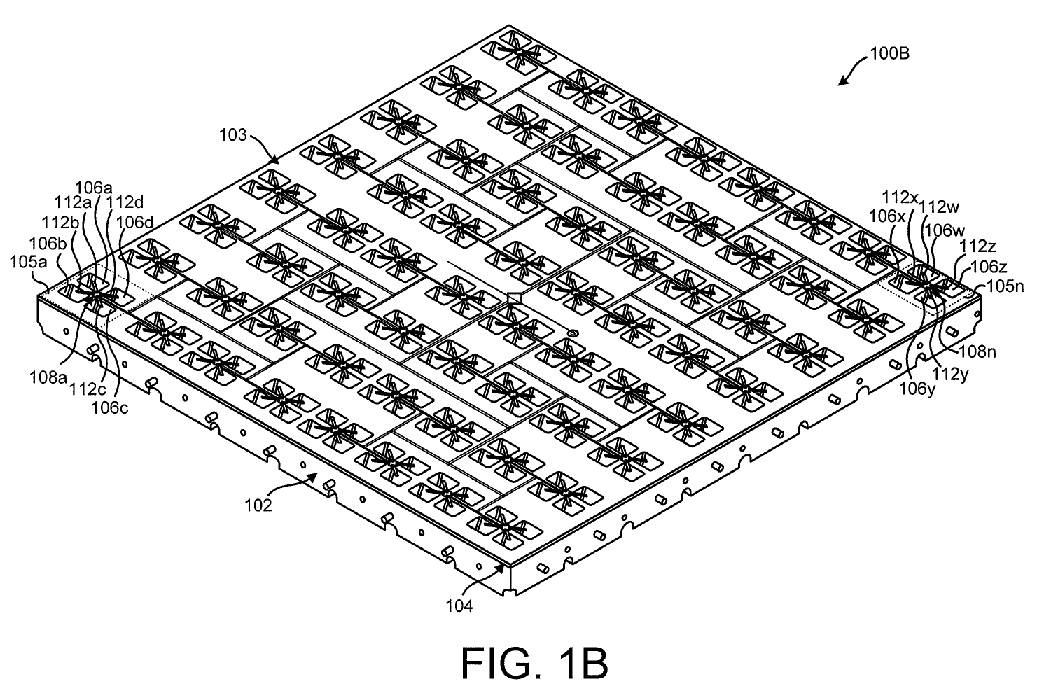

FIG. 1A illustrates a perspective view of a portion of a phased array antenna panel according to one implementation of the present application. As shown in FIG. 1A, phased array antenna panel 100A includes metallic base 102, substrate 104, a plurality of dedicated cavities, such as dedicated cavities 106a, 106b, 106c, 106d, 106w, 106x, 106y and 106z, (hereinafter collectively referred to as dedicated cavities 106), a plurality of semiconductor dies, such as semiconductor dies 108a and 108n, (hereinafter collectively referred to as semiconductor dies 108), and a plurality of antenna probes, such as antenna probes 112a, 112b, 112c, 112d, 112w, 112x, 112y and 112z, (hereinafter collectively referred to as antenna probes 112). RF front end unit 105a includes antenna probes 112a, 112b, 112c and 112d situated over dedicated cavities 106a, 106b, 106c and 106d, respectively. RF front end unit 105n includes antenna probes 112w, 112x, 112y and 112z situated over dedicated cavities 106w, 106x, 106y and 106z, respectively.

As illustrated in FIG. 1A, substrate 104 is situated over metallic base 102. Semiconductor dies 108 are situated over substrate 104. Dedicated cavities 106 extend through substrate 104 into metallic base 102. The formation of dedicated cavities 106 through substrate 104 into metallic base 102 creates ridges on top side 103 of phased array antenna panel 100A, where the ridges form a grid pattern. Semiconductor dies 108 are situated over the intersections of the ridges, and coupled to a group of neighboring dedicated cavities through the corresponding antenna probes. For example, semiconductor die 108a is coupled to dedicated cavities 106a, 106b, 106c and 106d through antenna probes 112a, 112b, 112c and 112d, respectively, while semiconductor die 108n is coupled to dedicated cavities 106w, 106x, 106y and 106z through antenna probes 112w, 112x, 112y and 112z, respectively.

In the present implementation, metallic base 102 includes aluminum or aluminum alloy. In another implementation, metallic base 102 may include copper or other suitable metallic material. In the present implementation, substrate 104 is a low-cost substrate, such as a printed circuit/wiring board with conductive traces formed therein. In one implementation, substrate 104 may include FR-4 material, which is low cost and can deliver robust performance and durability. In one implementation, substrate 104 may include conductive traces that carry signals from each of semiconductor dies 108 to a master chip (not explicitly shown in FIG. 1A), for example. In the present implementation, dedicated cavities 106 are air cavities, as air has a low dielectric constant and is an excellent dielectric material for radio frequency antenna applications. In another implementation, dedicated cavities 106 may be filled with other suitable dielectric material with a low dielectric constant.

As illustrated in FIG. 1A, a single antenna probe extends over a corresponding one of dedicated cavities 106, and is electrically coupled to a corresponding one of semiconductor dies 108. As such, each of semiconductor dies 108 is electrically coupled to four antenna probes, each extending over one of four neighboring dedicated cavities. For example, dedicated cavities 106a, 106b, 106c and 106d are quad split cavities, each of which has a single antenna probe extended above. As shown in FIG. 1A, each of dedicated cavities 106a, 106b, 106c and 106d has a sector-shaped top opening with a central angle of approximately 90 degrees. As can be seen in FIG. 1A, each of the sector-shaped top openings of dedicated cavities 106a, 106b, 106c and 106d is approximately a quadrant or a quarter of a circle. Antenna probes 112a, 112b, 112c and 112d extend from a central portion on substrate 104 in the center of the four sector-shaped openings, and over dedicated cavities 106a, 106b, 106c and 106d, respectively.

In the present implementation, each of dedicated cavities 106a, 106b, 106c and 106d includes a single antenna probe, such as a horizontal-polarization antenna probe or a vertical-polarization antenna probe. For example, in one implementation, antenna probes 112a and 112c may each be a horizontal-polarization antenna probe, while antenna probes 112b and 112d may each be a vertical-polarization antenna probe. In another implementation, antenna probes 112a and 112c may be a differential pair of horizontal-polarization (e.g., H+ and H−, respectively) antenna probes, while antenna probes 112b and 112d may be a differential pair of vertical-polarization (e.g., V+ and V−, respectively) antenna probes. In one implementation, dedicated cavities 106a and 106c may each be a dedicated horizontal-polarization cavity, while dedicated cavities 106b and 106d may each be a dedicated vertical-polarization cavity. It should be noted that the polarization of each of the above mentioned elements may be changed to the opposite polarization, for example, from horizontal-polarization to vertical-polarization and vice versa, without departing from the inventive concepts of the present application.

As illustrated in FIG. 1A, RF front end unit 105n includes antenna probes 112w, 112x, 112y and 112z situated over dedicated cavities 106w, 106x, 106y and 106z, respectively. For example, dedicated cavities 106w, 106x, 106y and 106z are quad split cavities, each of which has a single antenna probe extended above. As shown in FIG. 1A, each of dedicated cavities 106w, 106x, 106y and 106z has a sector-shaped top opening, with a central angle of approximately 90 degrees. As can be seen in FIG. 1A, each of the sector-shaped top openings of dedicated cavities 106w, 106x, 106y and 106z is approximately a quadrant or a quarter of a circle. Antenna probes 112w, 112x, 112y and 112z each extends from a central portion on substrate 104 in the center of the four sector-shaped openings, and over dedicated cavities 106w, 106x, 106y and 106z, respectively. In the present implementation, each of dedicated cavities 106w, 106x, 106y and 106z includes a single antenna probe, such as a horizontal-polarization antenna probe or a vertical-polarization antenna probe. For example, in one implementation, antenna probes 112w and 112y may each be a horizontal-polarization antenna probe, while antenna probes 112x and 112z may each be a vertical-polarization antenna probe. In another implementation, antenna probes 112w and 112y may be a differential pair of horizontal-polarization antenna probes (e.g., H+ and H−, respectively), while antenna probes 112x and 112z may be a differential pair of vertical-polarization antenna probes (e.g., V+ and V−, respectively).

In one implementation, dedicated cavities 106w and 106y may each be a dedicated horizontal-polarization cavity, while dedicated cavities 106x and 106z may each be a dedicated vertical-polarization cavity. It should be noted that the polarization of each of the above mentioned elements may be changed to the opposite polarization, for example, from horizontal-polarization to vertical-polarization and vice versa, without departing from the inventive concepts of the present application. In the present implementation, because each antenna probe extends over only its own dedicated cavity, such as a dedicated vertical-polarization cavity or a dedicated horizontal-polarization cavity, the coupling between the antenna probes, for example between a horizontal-polarization antenna probe and a vertical-polarization antenna probe, can be effectively reduced.

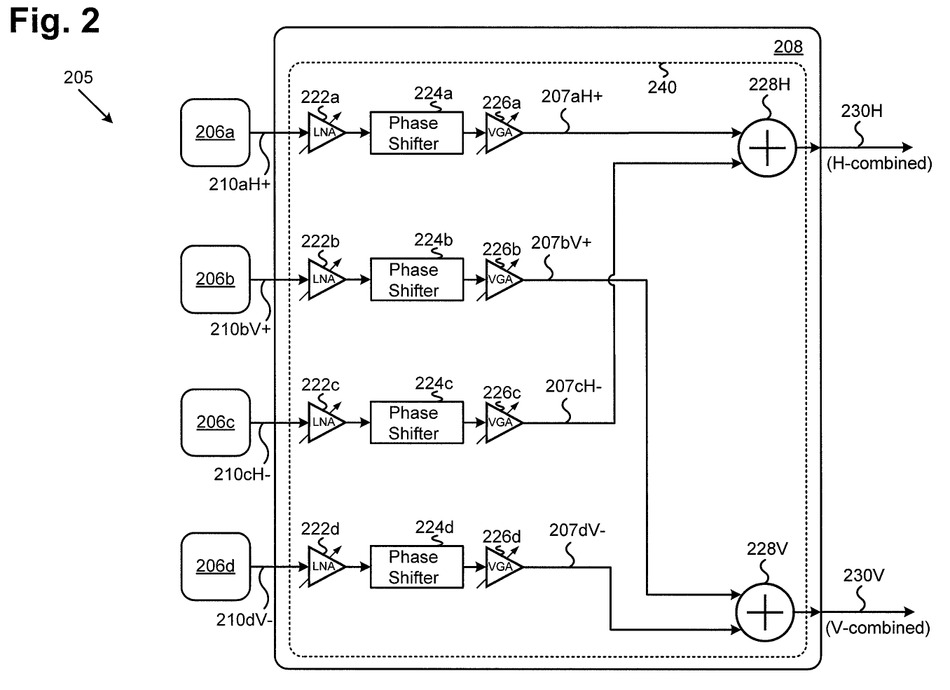

In the present implementation, each of semiconductor dies 108 is electrically coupled to four antenna probes, each extending over a corresponding one of four neighboring dedicated cavities, such as quad split cavities. The four antenna probes are electrically coupled to a radio frequency (RF) front end circuit (not explicitly shown in FIG. 1A) integrated in a corresponding one of semiconductor dies 108. In one implementation, the RF front end circuit is configured to receive RF signals from the group of neighboring dedicated cavities through the corresponding antenna probes, amplify the RF signals, reduce signal noise, adjust the phase of the RF signals, and combine the RF signals, for example. Details of the RF front end circuit in each of semiconductor dies 108 are discussed with reference to FIG. 2.

Referring to FIG. 1B, FIG. 1B illustrates a perspective view of a portion of a phased array antenna panel according to one implementation of the present application. As illustrated in FIG. 1B, phased array antenna panel 100B includes metallic base 102, substrate 104, a plurality of cavities, such as dedicated cavities 106a, 106b, 106c, 106d, 106w, 106x, 106y and 106z, (hereinafter collectively referred to as dedicated cavities 106), a plurality of semiconductor dies, such as semiconductor dies 108a and 108n, (hereinafter collectively referred to as semiconductor dies 108), and a plurality of antenna probes, such as antenna probes 112a, 112b, 112c, 112d, 112w, 112x, 112y and 112z (hereinafter collectively referred to as antenna probes 112). RF front end unit 105a includes antenna probes 112a, 112b, 112c and 112d situated over dedicated cavities 106a, 106b, 106c and 106d, respectively. RF front end unit 105n includes antenna probes 112w, 112x, 112y and 112z situated over dedicated cavities 106w, 106x, 106y and 106z, respectively.

In the present implementation, metallic base 102, substrate 104, semiconductor dies 108, and antenna probes 112 in FIG. 1B may substantially correspond to metallic base 102, substrate 104, semiconductor dies 108, and antenna probes 112, respectively, of phased array antenna panel 100A in FIG. 1A. In contrast to dedicated cavities 106 in FIG. 1A each having a sector-shaped top opening on top side 103 of phased array antenna panel 100A, as shown in FIG. 1B, each of dedicated cavities 106 has a rectangular-shaped top opening, such as a square top opening, on top side 103 of phased array antenna panel 100B.

As illustrated in FIG. 1B, each of dedicated cavities 106 includes a single antenna probe, such as a horizontal-polarization antenna probe or a vertical-polarization antenna probe. Each of the antenna probes extends over a corresponding one of dedicated cavities 106, and is electrically coupled to a corresponding one of semiconductor dies 108. As such, each of semiconductor dies 108 is electrically coupled to four antenna probes, each extending over one of four neighboring dedicated cavities. In the present implementation, because each antenna probe extends over only its own dedicated cavity, such as a dedicated vertical-polarization cavity or a dedicated horizontal-polarization cavity, the coupling between the antenna probes, for example between a horizontal-polarization antenna probe and a vertical-polarization antenna probe, can be effectively reduced.

FIG. 2 illustrates a functional block diagram of a radio frequency (RF) front end circuit of a semiconductor die according to one implementation of the present application. As illustrated in FIG. 2, front end unit 205 includes dedicated cavities 206a, 206b, 206c and 206d coupled to radio frequency (RF) front end circuit 240 in semiconductor die 208. In the present implementation, dedicated cavities 206a, 206b, 206c and 206d may substantially correspond to dedicated cavities 106a, 106b, 106c and 106d, respectively, in FIGS. 1A and 1B. In the present implementation, semiconductor die 208 may correspond to semiconductor die 108a in FIGS. 1A and 1B. It is noted that the antennas probes as shown in FIGS. 1A and 1B are omitted from FIG. 2 for conceptual clarity.

In the present implementation, dedicated cavities 206a, 206b, 206c and 206d may be configured to receive RF signals from one or more commercial geostationary communication satellites or low earth orbit satellites, for example, which typically employ linearly polarized signals defined at the satellite with a horizontally-polarized (H) signal having its electric field oriented parallel with the equatorial plane and a vertically-polarized (V) signal having its electric-field oriented perpendicular to the equatorial plane. As illustrated in FIG. 2, each of dedicated cavities 206a, 206b, 206c and 206d is configured to provide a horizontally-polarized (H) input or a vertically-polarized (V) input to semiconductor die 208. For example, dedicated cavity 206a may provide positive differential horizontally-polarized input (also referred to as “antenna input” in the present application) 210aH+ to RF front end circuit 240, while dedicated cavity 206b may provide positive differential vertically-polarized input (also referred to as “antenna input” in the present application) 210bV+ to RF front end circuit 240. Also, dedicated cavity 206c may provide negative differential horizontally-polarized input 210cH− (also referred to as “antenna input” in the present application) to RF front end circuit 240, while dedicated cavity 206d may provide negative differential vertically-polarized input 210dV− (also referred to as “antenna input” in the present application) to RF front end circuit 240.

In the present implementation, positive differential horizontally-polarized input 210aH+ from dedicated cavity 206a may be provided to a receiving circuit including low noise amplifier (LNA) 222a, phase shifter 224a and variable gain amplifier (VGA) 226a. As illustrated in FIG. 2, LNA 222a is configured to generate an output to phase shifter 224a, phase shifter 224a is configured to generate an output to VGA 226a, and VGA 226a is configured to generate positive differential horizontally-polarized output 207aH+ to summation block 228H. Also, positive differential vertically-polarized input 210bV+ from dedicated cavity 206b may be provided to a receiving circuit including low noise amplifier (LNA) 222b, phase shifter 224b and variable gain amplifier (VGA) 226b. As illustrated in FIG. 2, LNA 222b is configured to generate an output to phase shifter 224b, phase shifter 224b is configured to generate an output to VGA 226b, and VGA 226b is configured to generate positive differential vertically-polarized output 207bV+ to summation block 228V.

Similarly, negative differential horizontally-polarized input 210cH− from dedicated cavity 206c may be provided to a receiving circuit including low noise amplifier (LNA) 222c, phase shifter 224c and variable gain amplifier (VGA) 226c. As illustrated in FIG. 2, LNA 222c is configured to generate an output to phase shifter 224c, phase shifter 224c is configured to generate an output to VGA 226c, and VGA 226c is configured to generate negative differential horizontally-polarized output 207cH− to summation block 228H. In addition, negative differential vertically-polarized input 210dV− from dedicated cavity 206d may be provided to a receiving circuit including low noise amplifier (LNA) 222d, phase shifter 224d and variable gain amplifier (VGA) 226d. As illustrated in FIG. 2, LNA 222d is configured to generate an output to phase shifter 224d, phase shifter 224d is configured to generate an output to VGA 226d, and VGA 226d is configured to generate negative differential vertically-polarized output 207dV− to summation block 228V.

As illustrated in FIG. 2, amplified and phase shifted positive differential horizontally-polarized output 207aH+ from dedicated cavity 206a, and amplified and phase shifted negative differential horizontally-polarized output 207cH− from dedicated cavity 206c, are provided to summation block 228H, that is configured to sum all of the powers and combine all of the phases of the amplified and phase shifted positive and negative differential horizontally-polarized outputs, to provide horizontally-polarized combined signal 230H, for example, to a master chip (not explicitly shown in FIG. 2). Also, amplified and phase shifted positive differential vertically-polarized output 207bV+ from dedicated cavity 206b and amplified and phase shifted negative differential vertically-polarized output 207dV− from dedicated cavity 206d, are provided to summation block 228V, that is configured to sum all of the powers and combine all of the phases of the amplified and phase shifted positive and negative differential vertically-polarized outputs, to provide vertically-polarized combined signal 230V, for example, to the master chip (not explicitly shown in FIG. 2).

In another implementation, instead of using differential signaling, dedicated cavities 206a, 206b, 206c and 206d may be used for single-ended signaling. In such case, dedicated cavity 206a may be a dedicated horizontal-polarization cavity that is coupled to a single-ended horizontally-polarized antenna probe for receiving a horizontally-polarized signal, while dedicated cavity 206b may be a dedicated vertical-polarization cavity that is coupled to a single-ended vertically-polarized antenna probe for receiving a vertically-polarized signal. In this implementation, dedicated cavity 206c may be a dedicated horizontal-polarization cavity that is coupled to another single-ended horizontally-polarized antenna probe for receiving a horizontally-polarized signal, while dedicated cavity 206d may be a dedicated vertical-polarization cavity that is coupled to another single-ended vertically-polarized antenna probe for receiving a vertically-polarized signal.

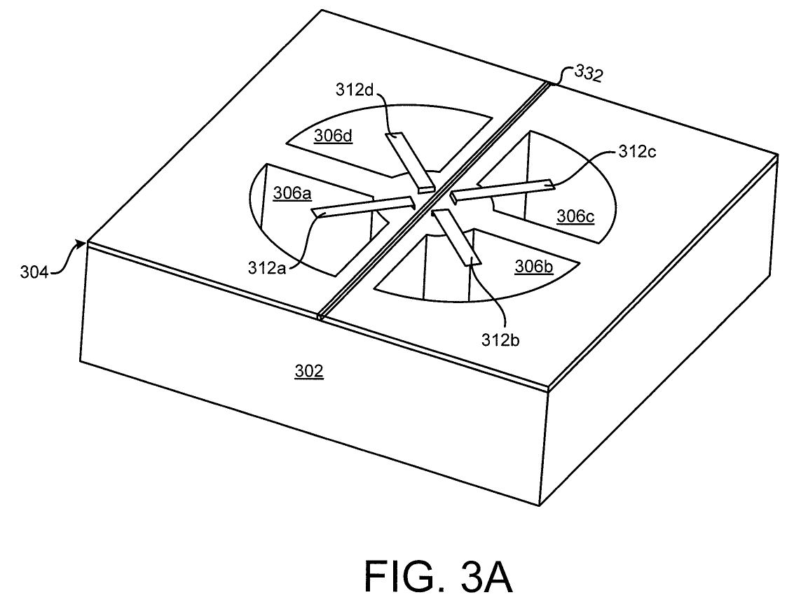

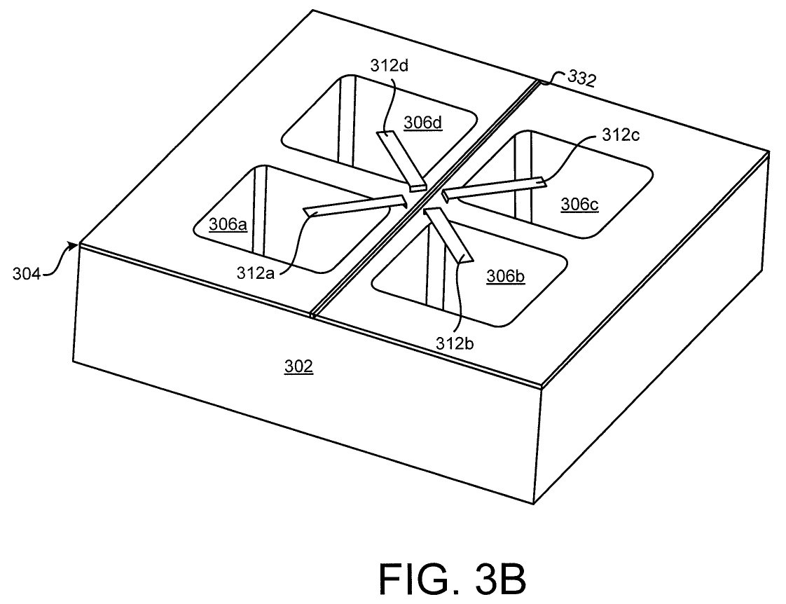

FIG. 3A illustrates a perspective view of quad split cavities of a phased array antenna panel according to one implementation of the present application. As shown in FIG. 3A, substrate 304 is situated over metallic base 302. Dedicated cavities 306a, 306b, 306c and 306d each extend through substrate 304 into metallic base 302. Each of dedicated cavities 306a, 306b, 306c and 306d has a sector-shaped top opening. In the present implementation, metallic base 302, substrate 304, and dedicated cavities 306a, 306b, 306c and 306d in FIG. 3A, may substantially correspond to metallic base 102, substrate 104, and dedicated cavities 106a, 106b, 106c and 106d, respectively, of phased array antenna panel 100A in FIG. 1A.

In the present implementation, antenna probe 312a extends over dedicated cavity 306a, where antenna probe 312a may provide a positive differential horizontally-polarized input to an RF front end circuit, such as positive differential horizontally-polarized input 210aH+ provided to RF front end circuit 240 on semiconductor die 208 in FIG. 2. Antenna probe 312b extends over dedicated cavity 306b, where antenna probe 312b may provide a positive differential vertically-polarized input to the RF front end circuit, such as positive differential vertically-polarized input 210bV+ provided to RF front end circuit 240 on semiconductor die 208 in FIG. 2. In addition, antenna probe 312c extends over dedicated cavity 306c, where antenna probe 312c may provide a negative differential horizontally-polarized input to the RF front end circuit, such as negative differential horizontally-polarized input 210cH− provided to RF front end circuit 240 on semiconductor die 208 in FIG. 2. Antenna probe 312d extends over dedicated cavity 306d, where antenna probe 312d may provide a negative differential vertically-polarized input to the RF front end circuit, such as negative differential vertically-polarized input 210dV− provided to RF front end circuit 240 on semiconductor die 208 in FIG. 2.

In one implementation, instead of using differential signaling, dedicated cavities 306a, 306b, 306c and 306d may be used for single-ended signaling In such case, dedicated cavity 306a may be a dedicated horizontal-polarization cavity that is coupled to antenna probe 312a, such as a single-ended horizontal-polarization antenna probe, for receiving a single-ended horizontally-polarized signal, while dedicated cavity 306b may be a dedicated vertical-polarization cavity that is coupled to antenna probe 312b, such as a single-ended vertical-polarization antenna probe, for receiving a single-ended vertically-polarized signal. Additionally, dedicated cavity 306c may be another dedicated horizontal-polarization cavity that is coupled to antenna probe 312c, such as another single-ended horizontal-polarization antenna probe, for receiving another single-ended horizontally-polarized signal, while dedicated cavity 306d may be another dedicated vertical-polarization cavity that is coupled to antenna probe 312d, such as another single-ended vertical-polarization antenna probe, for receiving another single-ended vertically-polarized signal.

In one implementation, a semiconductor die (not explicitly shown in FIG. 3A), such as semiconductor die 108a in FIG. 1A, may be directly situated on, and mechanically and electrically coupled to, antenna probes 312a, 312b, 312c and 312d. As such, each of the feed lines connecting each antenna probe to the semiconductor die can have a substantially zero length, thereby reducing manufacturing cost and signal loss. The semiconductor die having the RF front end circuit may provide a horizontally-polarized combined signal and a vertically-polarized combined signal, such as horizontally-polarized combined signal 230H and vertically-polarized combined signal 230V shown in FIG. 2, to electrical connector 332, which may carry the horizontally-polarized combined signal and the vertically-polarized combined signal to a master chip (not explicitly shown in FIG. 3A).

In one implementation, dedicated cavities 306a, 306b, 306c and 306d in FIG. 3A may be floating, i.e., not connected to any conducting path to ground or a voltage reference point. In another implementation, dedicated cavities 306a, 306b, 306c and 306d may be electrically coupled to a DC potential, such as ground. Having a single antenna probe over each dedicated cavity can reduce the coupling of electromagnetic waves among the antenna probes. For example, a dedicated vertical-polarization cavity and a dedicated horizontal-polarization cavity can effectively reduce the coupling between a vertical-polarization antenna probe and a horizontal-polarization antenna probe over the respective dedicated cavities. As a result, a phased array antenna panel, such as phased array antenna panel 100A in FIG. 1A, may have reduced loss and increased bandwidth, gain, directivity and radiation pattern symmetry.

FIG. 3B illustrates a perspective view of quad split cavities of a phased array antenna panel according to one implementation of the present application. In one implementation, metallic base 302, substrate 304, dedicated cavities 306a, 306b, 306c and 306d, and antenna probes 312a, 312b, 312c and 312d in FIG. 3B, may substantially correspond to metallic base 102, substrate 104, dedicated cavities 106a, 106b, 106c and 106d, and antenna probes 112a, 112b, 112c and 112d, respectively, of phased array antenna panel 100B in FIG. 1B. In one implementation, metallic base 302, substrate 304, antenna probes 312a, 312b, 312c and 312d, and electrical connector 332 may substantially correspond metallic base 302, substrate 304, antenna probes 312a, 312b, 312c and 312d, and electrical connector 332, respectively, in FIG. 3A. In contrast to FIG. 3A, each of dedicated cavities 306a, 306b, 306c and 306d in FIG. 3B has a rectangular-shaped top opening, such as a square opening, whereas each of dedicated cavities 306a, 306b, 306c and 306d in FIG. 3A has a sector-shaped top opening. In one implementation, dedicated cavities 306a, 306b, 306c and 306d in FIG. 3B may be floating, i.e., not connected to any conducting path to ground or a voltage reference point. In another implementation, dedicated cavities 306a, 306b, 306c and 306d may be electrically coupled to a DC potential, such as ground. Having a single antenna probe over each dedicated cavity can reduce the coupling of electromagnetic waves among the antenna probes. As a result, a phased array antenna panel, such as phased array antenna panel 100B in FIG. 1B, may have reduced loss and increased bandwidth, gain, directivity and radiation pattern symmetry.

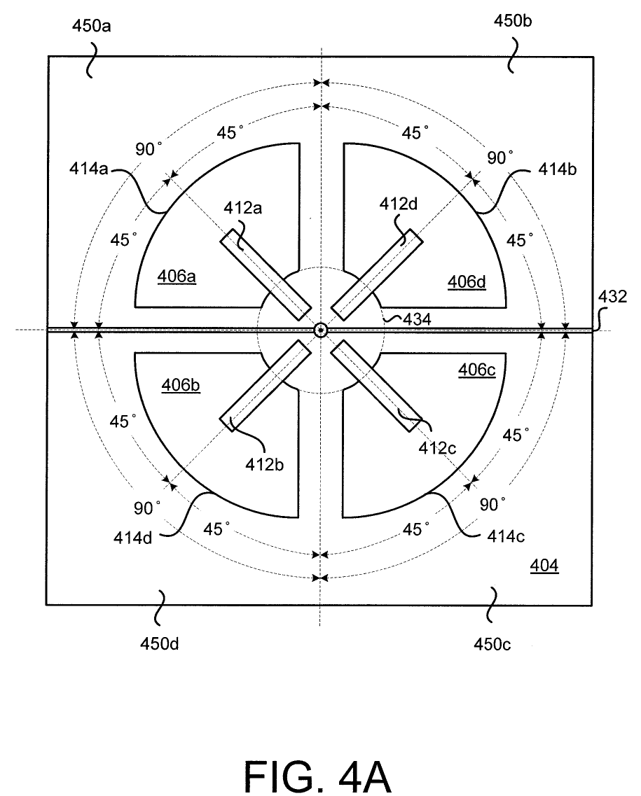

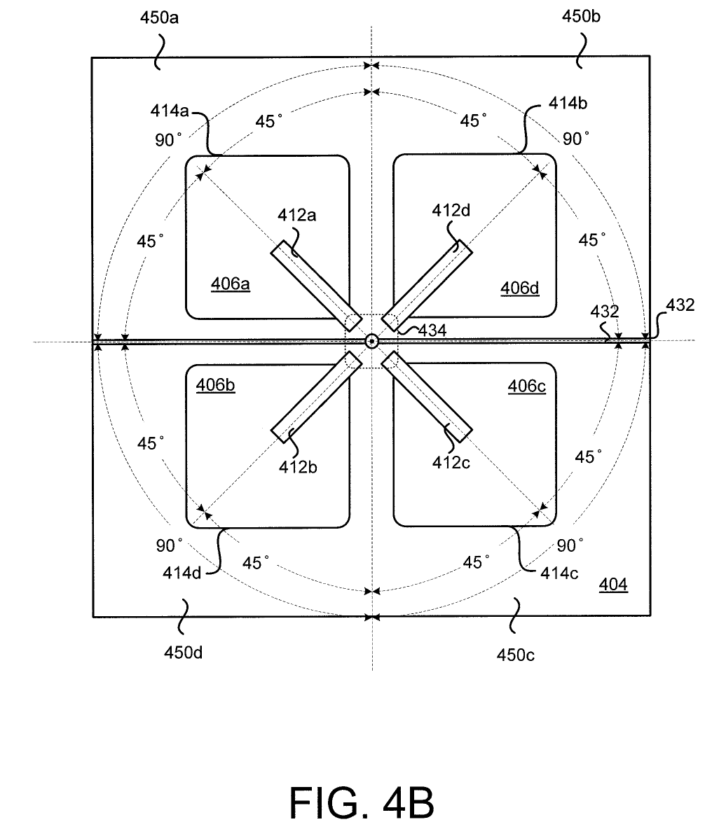

FIG. 4A illustrates a top plan view of quad split cavities of a phased array antenna panel according to one implementation of the present application. As shown in FIG. 4A, substrate 404 is situated over a metallic base (not explicitly shown in FIG. 4A), such as metallic base 302 in FIG. 3A. Dedicated cavities 406a, 406b, 406c and 406d each extend through substrate 404 into the metallic base. Dedicated cavities 406a, 406b, 406c and 406d each have a sector-shaped top opening in quadrants 450a, 450b, 450c and 450d, respectively. In one implementation, metallic base 402, substrate 404, dedicated cavities 406a, 406b, 406c and 406d, and antenna probes 412a, 412b, 412c and 412d in FIG. 4A, may substantially correspond to metallic base 102, substrate 104, dedicated cavities 106a, 106b, 106c and 106d, and antenna probes 112a, 112b, 112c and 112d, respectively, in FIG. 1A. In one implementation, substrate 404, dedicated cavities 406a, 406b, 406c and 406d, and antenna probes 412a, 412b, 412c and 412d may also substantially correspond to substrate 304, dedicated cavities 306a, 306b, 306c and 306d, and antenna probes 312a, 312b, 312c and 312d, respectively, in FIG. 3A. As shown in FIG. 4A, each of dedicated cavities 406a, 406b, 406c and 406d has a sector-shaped top opening, with a central angle of approximately 90 degrees. Each of the sector-shaped top openings of dedicated cavities 406a, 406b, 406c and 406d is approximately a quadrant or a quarter of a circle. Antenna probes 412a, 412b, 412c and 412d each extend from central portion 434 on substrate 404, and over dedicated cavities 406a, 406b, 406c and 406d, respectively. As can be seen in FIG. 4A, antenna probe 412a extends from central portion 434 on substrate 404 toward the middle of sector-shaped top opening 414a of dedicated cavity 406a along the 45-degree line in quadrant 450a. Antenna probe 412b extends from central portion 434 on substrate 404 toward the middle of sector-shaped top opening 414b of dedicated cavity 406b along the 45-degree line in quadrant 450b. Antenna probe 412c extends from central portion 434 on substrate 404 toward the middle of sector-shaped top opening 414c of dedicated cavity 406c along the 45-degree line in quadrant 450c. Antenna probe 412d extends from central portion 434 on substrate 404 toward the middle of sector-shaped top opening 414d of dedicated cavity 406d along the 45-degree line in quadrant 450d.

In the present implementation, each of dedicated cavities 406a, 406b, 406c and 406d includes a single antenna probe, such as a horizontal-polarization antenna probe or a vertical-polarization antenna probe. In one implementation, antenna probes 412a and 412c may be a differential pair of horizontal-polarization (e.g., H+ and H−, respectively) antenna probes, while antenna probes 412b and 412d may be a differential pair of vertical-polarization (e.g., V+ and V−, respectively) antenna probes. In another implementation, antenna probes 412a and 412c may each be a horizontal-polarization antenna probe, while antenna probes 412b and 412d may each be a vertical-polarization antenna probe. In one implementation, dedicated cavities 406a and 406c may each be a dedicated horizontal-polarization cavity, while dedicated cavities 406b and 406d may each be a dedicated vertical-polarization cavity.

FIG. 4B illustrates a top plan view of quad split cavities of a phased array antenna panel according to one implementation of the present application. As shown in FIG. 4B, substrate 404 is situated over a metallic base (not explicitly shown in FIG. 4b), such as metallic base 302 in FIG. 3B. Dedicated cavities 406a, 406b, 406c and 406d each extend through substrate 404 into the metallic base. Dedicated cavities 406a, 406b, 406c and 406d each have a rectangular-shaped, such as a square top opening, top opening in quadrants 450a, 450b, 450c and 450d, respectively. In one implementation, metallic base 402, substrate 404, dedicated cavities 406a, 406b, 406c and 406d, and antenna probes 412a, 412b, 412c and 412d in FIG. 4B, may substantially correspond to metallic base 102, substrate 104, dedicated cavities 106a, 106b, 106c and 106d, and antenna probes 112a, 112b, 112c and 112d, respectively, in FIG. 1B. In one implementation, substrate 404, dedicated cavities 406a, 406b, 406c and 406d, and antenna probes 412a, 412b, 412c and 412d may also substantially correspond to substrate 304, dedicated cavities 306a, 306b, 306c and 306d, and antenna probes 312a, 312b, 312c and 312d, respectively, in FIG. 3B.

As shown in FIG. 4B, each of dedicated cavities 406a, 406b, 406c and 406d has a rectangular-shaped top opening, such as a square top opening. Antenna probes 412a, 412b, 412c and 412d each extend from central portion 434 on substrate 404, and over dedicated cavities 406a, 406b, 406c and 406d, respectively. As can be seen in FIG. 4B, antenna probe 412a extends from central portion 434 on substrate 404 toward the middle of rectangular-shaped top opening 414a of dedicated cavity 406a along the 45-degree line in quadrant 450a. Antenna probe 412b extends from central portion 434 on substrate 404 toward the middle of rectangular-shaped top opening 414b of dedicated cavity 406b along the 45-degree line in quadrant 450b. Antenna probe 412c extends from central portion 434 on substrate 404 toward the middle of rectangular-shaped top opening 414c of dedicated cavity 406c along the 45-degree line in quadrant 450c. Antenna probe 412d extends from central portion 434 on substrate 404 toward the middle of rectangular-shaped top opening 414d of dedicated cavity 406d along the 45-degree line in quadrant 450d.

In the present implementation, each of dedicated cavities 406a, 406b, 406c and 406d includes a single antenna probe, such as a horizontal-polarization antenna probe or a vertical-polarization antenna probe. In one implementation, antenna probes 412a and 412c may be a differential pair of horizontal-polarization (e.g., H+ and H−, respectively) antenna probes, while antenna probes 412b and 412d may be a differential pair of vertical-polarization (e.g., V+ and V−, respectively) antenna probes. In another implementation, antenna probes 412a and 412c may each be a horizontal-polarization antenna probe, while antenna probes 412b and 412d may each be a vertical-polarization antenna probe. In one implementation, dedicated cavities 406a and 406c may each be a dedicated horizontal-polarization cavity, while dedicated cavities 406b and 406d may each be a dedicated vertical-polarization cavity.

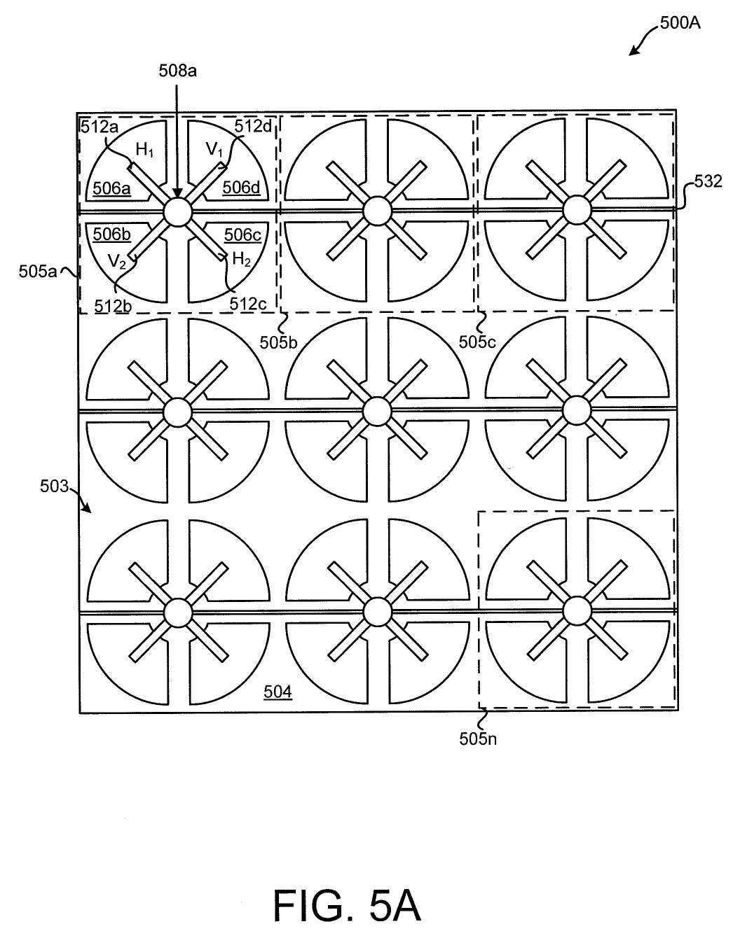

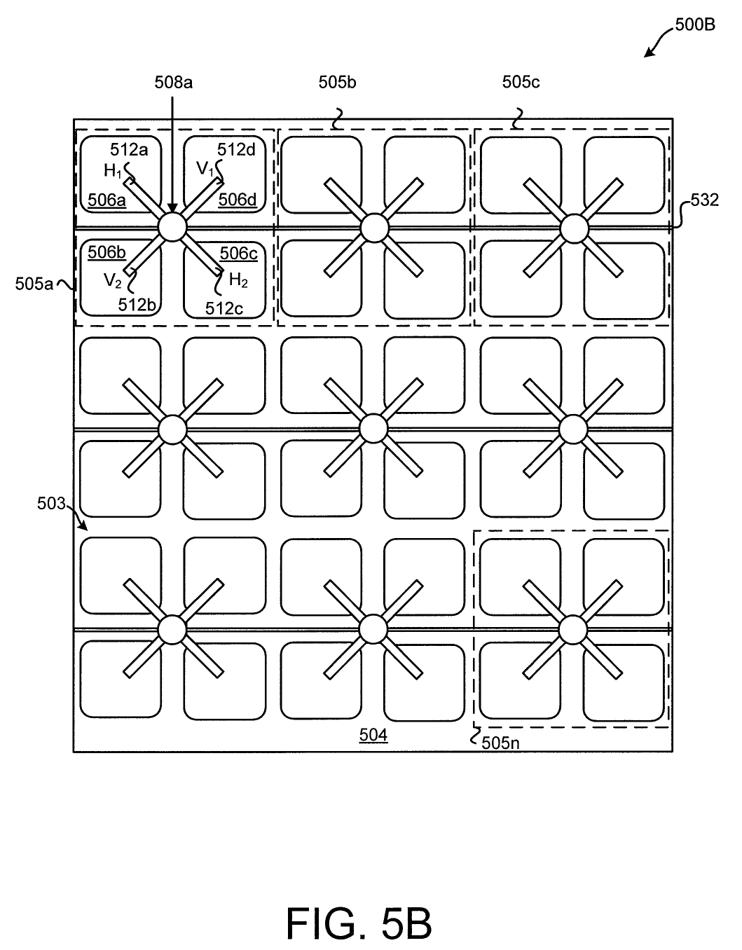

Referring now to FIG. 5A, FIG. 5A illustrates a top plan view of a plurality of quad split cavities in a phased array antenna panel according to one implementation of the present application. As illustrated in FIG. 5A, phased array antenna panel 500A includes a plurality of RF front end units, such as RF front end units 505a, 505b, 505c and 505n, where each of the RF font end units includes quad split cavities each with a single antenna probe. In one implementation, RF front end unit 505a may substantially correspond to RF front end unit 105a in FIG. 1A.

As shown in FIG. 5A, phased array antenna panel 500A includes substrate 504, a plurality of dedicated cavities, such as dedicated cavities 506a, 506b, 506c, and 506d, (hereinafter collectively referred to as dedicated cavities 506), a plurality of semiconductor dies, such as semiconductor die 508a, (hereinafter collectively referred to as semiconductor dies 508), and a plurality of antenna probes, such as antenna probes 512a, 512b, 512c and 512d, (hereinafter collectively referred to as antenna probes 512). In the present implementation, substrate 504 is situated over a metallic base (not explicitly shown in FIG. 5A), such as metallic base 102 shown in FIG. 1A. Semiconductor dies 508 are situated over substrate 504. Dedicated cavities 506 extend through substrate 504 into the metallic base. The formation of dedicated cavities 506 through substrate 504 into the metallic base creates ridges on top side 503 of phased array antenna panel 500A, where the ridges form a grid pattern. Semiconductor dies 508 are situated over the intersections of the ridges, and coupled to a group of neighboring dedicated cavities through the corresponding antenna probes. For example, RF front end unit 505a includes dedicated cavities 506a, 506b, 506c and 506d, and antenna probes 512a, 512b, 512c and 512d situated over dedicated cavities 506a, 506b, 506c and 506d, respectively. Each of dedicated cavities 506a, 506b, 506c and 506d has a sector-shaped top opening. Semiconductor die 508a is coupled to dedicated cavities 506a, 506b, 506c and 506d through antenna probes 512a, 512b, 512c and 512d, respectively. Semiconductor die 508a may provide a horizontally-polarized combined signal and a vertically-polarized combined signal, for example, to a master chip (not explicitly shown in FIG. 5A) through electrical connector 532. Similarly, each of the semiconductor dies in RF front end units 505b and 505c may also provide a horizontally-polarized combined signal and a vertically-polarized combined signal, for example, to the master chip (not explicitly shown in FIG. 5A) through electrical connector 532.

As illustrated in FIG. 5A, dedicated cavities 506a and 506c, such as dedicated horizontal-polarization cavities, are situated on opposite sides of semiconductor die 508a. Dedicated cavities 506b and 506d, such as dedicated vertical-polarization cavities, are situated on opposite sides of semiconductor die 508a. Also, dedicated cavity 506a, such as a dedicated horizontal-polarization cavity, is situated adjacent to two dedicated vertical-polarization cavities, such as dedicated cavities 506b and 506d. Similarly, dedicated cavity 506c, such as a dedicated horizontal-polarization cavity, is situated adjacent to two dedicated vertical-polarization cavities, such as dedicated cavities 506b and 506d. In addition, dedicated cavity 506b, such as a dedicated vertical-polarization cavity, is situated adjacent to two dedicated horizontal-polarization cavities, such as dedicated cavities 506a and 506c. Dedicated cavity 506d, such as a dedicated vertical-polarization cavity, is situated adjacent to two dedicated horizontal-polarization cavities, such as dedicated cavities 506a and 506c. Antenna probes 512a and 512c, such as horizontal-polarization antenna probes, are orthogonal to antenna probes 512b and 512d, such as vertical-polarization antenna probes,

In the present implementation, because each of dedicated cavities 506 is associated with a single antenna probe extended thereabove, the coupling of electromagnetic waves among the antenna probes can be substantially reduced by the dedicated cavities. As a result, a phased array antenna panel, such as phased array antenna panel 500A in FIG. 5A, may have reduced loss and increased bandwidth, gain, directivity and radiation pattern symmetry.

FIG. 5B illustrates a top plan view of a plurality of quad split cavities in a phased array antenna panel according to one implementation of the present application. As illustrated in FIG. 5B, phased array antenna panel 500B includes a plurality of RF front end units, such as RF front end units 505a, 505b, 505c and 505n, where each of the RF font end units includes quad split cavities each with a single antenna probe. In one implementation, RF front end unit 505a may substantially correspond to RF front end unit 105a in FIG. 1B.

As shown in FIG. 5B, phased array antenna panel 500B includes substrate 504, a plurality of dedicated cavities, such as dedicated cavities 506a, 506b, 506c, and 506d, (hereinafter collectively referred to as dedicated cavities 506), a plurality of semiconductor dies, such as semiconductor die 508a, (hereinafter collectively referred to as semiconductor dies 508), and a plurality of antenna probes, such as antenna probes 512a, 512b, 512c and 512d, (hereinafter collectively referred to as antenna probes 512). In the present implementation, substrate 504 is situated over a metallic base (not explicitly shown in FIG. 5B), such as metallic base 102 shown in FIG. 1B. Semiconductor dies 508 are situated over substrate 504. Dedicated cavities 506 extend through substrate 504 into the metallic base. The formation of dedicated cavities 506 through substrate 504 into the metallic base creates ridges on top side 503 of phased array antenna panel 500B, where the ridges form a grid pattern. Semiconductor dies 508 are situated over the intersections of the ridges, and coupled to a group of neighboring dedicated cavities through the corresponding antenna probes. For example, RF front end unit 505a includes dedicated cavities 506a, 506b, 506c and 506d, and antenna probes 512a, 512b, 512c and 512d situated over dedicated cavities 506a, 506b, 506c and 506d, respectively. Each of dedicated cavities 506a, 506b, 506c and 506d has a rectangular-shaped top opening, such as a square top opening. Semiconductor die 508a is coupled to dedicated cavities 506a, 506b, 506c and 506d through antenna probes 512a, 512b, 512c and 512d, respectively. Semiconductor die 508a may provide a horizontally-polarized combined signal and a vertically-polarized combined signal, for example, to a master chip (not explicitly shown in FIG. 5B) through electrical connector 532. Similarly, each of the semiconductor dies in RF front end units 505b and 505c may also provide a horizontally-polarized combined signal and a vertically-polarized combined signal, for example, to the master chip (not explicitly shown in FIG. 5B) through electrical connector 532.

As illustrated in FIG. 5B, dedicated cavities 506a and 506c, such as dedicated horizontal-polarization cavities, are situated on opposite sides of semiconductor die 508a. Dedicated cavities 506b and 506d, such as dedicated vertical-polarization cavities, are situated on opposite sides of semiconductor die 508a. Also, dedicated cavity 506a, such as a dedicated horizontal-polarization cavity, is situated adjacent to two dedicated vertical-polarization cavities, such as dedicated cavities 506b and 506d. Similarly, dedicated cavity 506c, such as a dedicated horizontal-polarization cavity, is situated adjacent to two dedicated vertical-polarization cavities, such as dedicated cavities 506b and 506d. In addition, dedicated cavity 506b, such as a dedicated vertical-polarization cavity, is situated adjacent to two dedicated horizontal-polarization cavities, such as dedicated cavities 506a and 506c. Dedicated cavity 506d, such as a dedicated vertical-polarization cavity, is situated adjacent to two dedicated horizontal-polarization cavities, such as dedicated cavities 506a and 506c. Antenna probes 512a and 512c, such as horizontal-polarization antenna probes, are orthogonal to antenna probes 512b and 512d, such as vertical-polarization antenna probes,

In the present implementing, because each of dedicated cavities 506 is associated with a single antenna probe extended thereabove, the coupling of electromagnetic waves among the antenna probes can be substantially reduced by the dedicated cavities. As a result, a phased array antenna panel, such as phased array antenna panel 500B in FIG. 5B, may have reduced loss and increased bandwidth, gain, directivity and radiation pattern symmetry.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A phased array antenna panel comprising:
a substrate over a metallic base;
a semiconductor die situated over said substrate;
said semiconductor die being coupled to a vertical-polarization antenna probe and to a horizontal-polarization antenna probe;
said vertical-polarization antenna probe being situated over a dedicated vertical-polarization cavity and said horizontal-polarization antenna probe being situated over a dedicated horizontal-polarization cavity.

2. The phased array antenna panel of claim 1 wherein said dedicated vertical-polarization cavity and said dedicated horizontal-polarization cavity reduce coupling between said vertical-polarization antenna probe and said horizontal-polarization antenna probe.

3. The phased array antenna panel of claim 1 wherein said dedicated vertical-polarization cavity and said dedicated horizontal-polarization cavity each have a sector-shaped top opening.

4. The phased array antenna panel of claim 1 wherein said dedicated vertical-polarization cavity and said dedicated horizontal-polarization cavity each have a rectangular-shaped top opening.

5. The phased array antenna panel of claim 1 wherein said semiconductor die further comprises a radio frequency (RF) front end circuit coupled to said vertical-polarization antenna probe and said horizontal-polarization antenna probe.

6. The phased array antenna panel of claim 1 wherein said dedicated vertical-polarization cavity is situated adjacent to said dedicated horizontal-polarization cavity.

7. The phased array antenna panel of claim 1 wherein at least one of said dedicated vertical-polarization cavity and said dedicated horizontal-polarization cavity is an air cavity.

8. A phased array antenna panel comprising:
a substrate over a metallic base;
a semiconductor die situated over said substrate;
said semiconductor die being coupled to two differential vertical-polarization antenna probes and two differential horizontal-polarization antenna probes;
said two differential vertical-polarization antenna probes are situated in respective dedicated vertical-polarization cavities;
said two differential horizontal polarization antenna probes are situated in respective dedicated horizontal -polarization cavities;
wherein said dedicated vertical-polarization cavities and said dedicated horizontal-polarization cavities reduce coupling among said antenna probes.

9. The phased array antenna panel of claim 8 wherein said respective dedicated vertical-polarization cavities are situated on opposite sides of said semiconductor die.

10. The phased array antenna panel of claim 8 wherein said respective dedicated horizontal-polarization cavities are situated on opposite sides of said semiconductor die.

11. The phased array antenna panel of claim 8 wherein each of said respective dedicated vertical-polarization cavities is situated adjacent to one of said respective dedicated horizontal-polarization cavities.

12. The phased array antenna panel of claim 8 wherein each of said respective dedicated vertical-polarization cavities and each of said respective dedicated horizontal-polarization cavities has a sector-shaped top opening.

13. The phased array antenna panel of claim 8 wherein each of said respective dedicated vertical-polarization cavities and each of said respective dedicated horizontal-polarization cavities has a rectangular-shaped top opening.

14. The phased array antenna panel of claim 8 wherein each of said respective dedicated vertical-polarization cavities and each of said respective dedicated horizontal-polarization cavities is an air cavity.

15. A phased array antenna panel comprising:
a substrate over a metallic base;
a semiconductor die situated over said substrate;
said semiconductor die having a radio frequency (RF) front end circuit receiving antenna inputs from a vertical-polarization antenna probe and a horizontal-polarization antenna probe;
said vertical-polarization antenna probe being situated over a dedicated vertical-polarization cavity and said horizontal-polarization antenna probe being situated over a dedicated horizontal-polarization cavity.
wherein said RF front end circuit provides a combined horizontally-polarized signal and a combined vertically-polarized signal based on said antenna inputs.

16. The phased array antenna panel of claim 15 wherein said antenna inputs are coupled to phase shifters in said RF front end circuit.

17. The phased array antenna panel of claim 15 wherein said antenna inputs are coupled to low noise amplifiers in said RF front end circuit.

18. The phased array antenna panel of claim 15 wherein each of said dedicated vertical-polarization cavity and said dedicated horizontal-polarization cavity has a sector-shaped top opening.

19. The phased array antenna panel of claim 15 wherein each of said dedicated vertical-polarization cavity and said dedicated horizontal-polarization cavity has a rectangular-shaped top opening.

20. The phased array antenna panel of claim 15 wherein each of said dedicated vertical-polarization cavity and said dedicated horizontal-polarization cavity is an air cavity.
